(19) United States
(12) Patent Application Publication
(10) Pub. No.: US 2007/0135967 A1
(43) Pub. Date: Jun. 14, 2007

(54) Apparatus and method of controlling network-based robot

(76) Inventors: Seung Woog Jung, Daejeon-city (KR); Myung Chan Roh, Daejeon-city (KR); Choul Soo Jang, Daejeon-city (KR); Sung Hoon Kim, Daejeon-city (KR); Joong Bae Kim, Daejeon-city (KR); Kyeong Ho Lee, Daejeon-city (KR); Young Jo Cho, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/633,772

(22) Filed: Dec. 5, 2006

(30) Foreign Application Priority Data
Dec. 8, 2005 (KR) 10-2005-0119288
Aug. 1, 2006 (KR) 10-2006-0072691

(51) Int. Cl. G06F 19/00

(52) U.S. Cl. 700/248; 700/245

(57) ABSTRACT

A robot control apparatus and a method of controlling a robot are provided. The robot control apparatus includes an approval unit assigning a basic parameter required for communication including identification of each robot in order to prepare for communication when the robot is connected, a contents file acquisition unit acquiring a contents file including one or more contents for which each one has an execution subject and an execution time predetermined, and a contents file interpretation unit interpreting the contents file and transferring the contents to be executed at a predetermined time to the corresponding execution subject, so as to synchronously execute contents in two or more robots.

### CROSS-REFERENCE TO RELATED PATENT APPLICATION

This application claims the benefits of Korean Patent Application No. 10-2005-0119288, filed on Dec. 8, 2005, and Korean Patent Application No. 10-2006-0072691 filed on Aug. 1, 2006, in the Korean Intellectual Property Office, the disclosures of which are incorporated herein in their entirety by reference.

### BACKGROUND OF THE INVENTION

1. Field of the Invention

The present invention relates to an apparatus and method of controlling a network-based robot, and more particularly, to an apparatus and method of controlling a network-based robot capable of synchronously executing various contents in one or more robots and a personal computer.

2. Description of Related Art

Generally, basic contents which are executed in a robot have various forms such as speech information played a speaker, image information including a still image, a moving picture and texts which are reproduced by means of a display device installed in a robot, robot operational information including motions of the robot (arm, neck, leg, wheel, or the like), and an output in the form of a liquid crystal display (LCD) installed in the robot. However, the basic contents are executed for one robot in such a way that the outputting of the basic contents is continuously performed in the robot.

The present invention relates to an apparatus and method of synchronously reproducing various contents in one or more robots and a computer.

Since a high-priced multi-functional home service robot includes functions such as image processing, self-regulated driving, speech recognition, speech synthesis, motor and sensor control, and content execution, the high-priced robot requires many components, from basic hardware for controlling a motor or a sensor to high-performance hardware and software for performing and processing difficult tasks, thereby increasing manufacturing costs and the weight of the robot.

On the other hand, since the internal hardware of a low-priced toy or educational service robot is inferior, only predetermined simple functions. In addition, it is difficult to add a new function or contents to the low-priced robot.

Recently, in order to overcome these disadvantages, various new service robots using a network have emerged. In one type of new service robot, difficult tasks that are to be processed by the robot are processed by using a home server instead of the robot, so that the robot can be simplified.

The home server prepares a software module for service by downloading from an external service server. The robot requests the home server to process difficult tasks such as face recognition and self-regulated driving as necessary. By using the method described above, the manufacturing costs of the robot can be minimized. However, this method can only be used for one robot at a time. In the method, a module for executing contents exists, to some degree, inside the robot, and the robot requests the home server to process the difficult tasks as necessary.

Alternatively, a method in which the functions of the robot are minimized and the contents are executed in a remote super computer or a service server can be used. In this case each robot connects to super computer or a service server through a home gateway.

In addition, a method has been proposed in which contents are produced by using a content authorizing tool in a desktop computer and are downloaded into the robot in order to execute the contents inside the robot.

However, all the methods described above can only be used for executing contents in one robot at a time by means of a remote service server.

### SUMMARY OF THE INVENTION

The present invention provides an apparatus and method of controlling a network-based robot capable of synchronously executing various contents in one or more robots and a personal computer.

According to an aspect of the present invention, there is provided a robot control apparatus for synchronously executing contents in two or more robots, the robot control apparatus comprising: an approval unit assigning a basic parameter required for communication including identification of each robot in order to prepare for communication when the robot is connected; a contents file acquisition unit acquiring a contents file including one or more contents for which each one has an execution subject and an execution time predetermined; and a contents file interpretation unit interpreting the contents file and transferring the contents that are to be executed at a predetermined time to the corresponding execution subject.

In the aspect above, the robot control apparatus may further comprise a content execution unit comprising at least one of image and audio output parts for executing the contents when the subject of the contents is the robot control apparatus.

According to an embodiment of the present invention, content developers can develop various contents from simple contents requiring continuous output of the basic contents as a case where a robot reproduces music to complex contents requiring multiple robots to synchronously perform English conversations or role plays with one another.

The present invention includes a robot control apparatus which executes various contents stored in a computer and one or more robots which are connected to the robot control apparatus through a network.

The robot control apparatus loads a contents file stored in a computer and classifies the contents file into contents which are to be executed in the robot control apparatus and contents which are to be executed in the robot. The contents which are to be executed in the robot control apparatus are executed using resources including a monitor and a speaker of the robot control apparatus. On the other hand, the contents which are to be executed in the robot are transferred to the robot through a network to be executed.

The robot control apparatus according to an embodiment of the present invention guarantees synchronous execution of contents at a desired time in desired order.

As described above, according to an embodiment of the present invention, under environments in which a computer and one or more robots are connected through a wireless network, a robot control apparatus synchronously executes contents in multiple robots which are connected to the robot control apparatus through a network along with resources of the robot control apparatus such as a monitor and a speaker. And accordingly, the present invention overcomes a disadvantage in a robot control apparatus that contents are executed only in one robot. In addition, most of the content processing is performed in the robot control apparatus and content processing in the connected robot is minimized to reduce manufacturing costs of the robot.

In addition, the contents which are executed in the robot control apparatus can be executed directly in the robot control apparatus which is operated in a computer by downloading the contents through various mobile storage devices including a USB or the Internet without complicated procedures of installing the contents to the robot.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating the relationship between a robot control apparatus and a robot according to an embodiment of the present invention;

FIG. 2 is a block diagram of a robot control apparatus according to an embodiment of the present invention;

FIG. 3 is a schematic block diagram of a robot control apparatus according to another embodiment of the present invention;

FIG. 4 is a block diagram of a robot according to an embodiment of the present invention;

FIG. 5 is a block diagram illustrating an internal software structure of a robot according to an embodiment of the present invention;

FIG. 6 is a flowchart of a method of controlling a robot according to an embodiment of the present invention;

FIG. 7 is a flowchart of a method of controlling a robot according to another embodiment of the present invention;

FIG. 8 is a flowchart of a method of controlling a robot according to another embodiment of the present invention;

FIG. 9 is a contents file according to an embodiment of the present invention; and

FIG. 10 is a frame file according to an embodiment of the present invention.

### DETAILED DESCRIPTION OF THE INVENTION

Now, exemplary embodiments of a network-based robot control apparatus, a robot, and a method of controlling a robot will be described in detail with reference to the accompanying drawings.

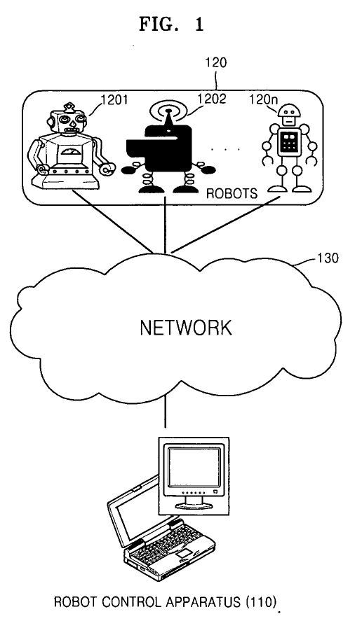

FIG. 1 is a schematic diagram illustrating the relationship between a robot control apparatus and the robots according to an embodiment of the present invention.

A robot control apparatus 110 for executing various contents stored in a computer are connected to one or more robots through a network 130.

Various networks can be used as the network 130. A wireless network having a high speed and a little data loss may be used. A wireless local area network (LAN) (IEEE 802.11x), a wireless universal serial bus (USB), Bluetooth, ZigBee, or an ultra wide bandwidth (UWB) can be used as the wireless network.

Communication equipment should be installed in the robot control apparatus 110 and the robots 120 for communicating with each other through the network 130. As an example, when the wireless LAN is used as the network 130, wireless LAN cards should be installed in the robot control apparatus 110 and the robots 120. In addition, a wireless access point, which is a part of network 130 equipment, is required for wireless communication between the robot control apparatus 110 and the robots 120.

The robot control apparatus 110 can be implemented as software and executed on a mobile notebook computer, a laptop computer, a personal digital assistance (PDA), or a desktop computer.

The robot control apparatus 110 loads contents stored in the computer and classifies the contents into contents which are to be executed in the robot control apparatus 110 and contents which are to be executed in the robots 120.

The robot control apparatus 110 executes the contents which are to be executed in the robot control apparatus 110 using internal resources including a monitor and a speaker. On the other hand, the robot control apparatus 110 transfers the contents which are to be executed in the robots to the robots 120 through the network 130 for execution.

In addition, the robot control apparatus 110 guarantees that the contents are synchronously executed in the robot control apparatus 110 and the robots 120 in a desired order and at a desired time when executing the contents.

In addition, the robots 120 should include basic hardware such as a speaker, a display device, and an actuator for executing contents which are transferred from the robot control apparatus 110, and software for operating and controlling the basic hardware.

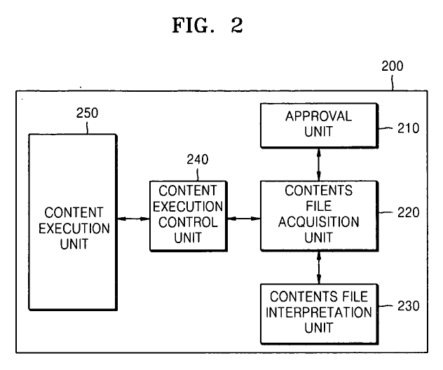

FIG. 2 is a block diagram of a robot control apparatus according to an embodiment of the present invention. Referring to FIG. 2, the apparatus 200 includes an approval unit 210, a contents file acquisition unit 220, a contents file interpreter 230, a content execution control unit 240, and a content execution unit 250.

The approval unit 210 in the robot control apparatus for synchronously executing contents in two or more robots assigns a basic parameter including identification required for communication with each robot, when the robot connects to the robot control apparatus.

The contents file acquisition unit 220 acquires a contents file including one or more contents for which each one has an execution subject and an execution time predetermined. The execution subject of the contents is the robot or the robot control apparatus.

The contents file interpretation unit 230 interprets the contents file and transfers contents that are to be executed at a predetermined time to a corresponding content subject.

The contents execution control unit 240 monitors an execution status of contents and issues a command including execution stop, pause, or resume execution of the content as necessary.

The content execution unit 250 executes the contents when the subject of the contents is the robot control apparatus. The content execution unit 250 has various output units including an image output unit and audio output unit.

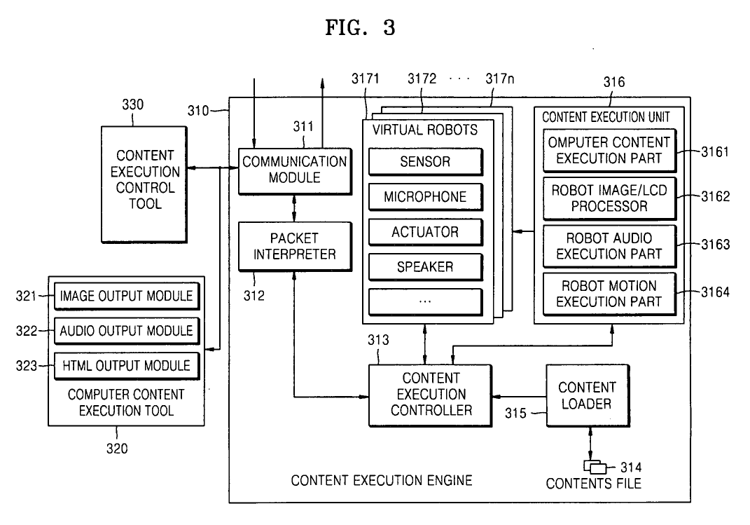

FIG. 3 is a schematic block diagram of a robot control apparatus according to another embodiment of the present invention. Referring to FIG. 3, the apparatus includes a content execution engine 310, a computer content execution tool 320, and a content execution control tool 330.

The content execution engine 310 loads and executes a contents file.

The computer content execution tool 320 executes contents that are to be executed on a computer and displays the contents on a screen.

The content execution control tool 330 monitors an execution status of contents and transfers a command to the content execution engine 310 as necessary.

The content execution engine 310 includes a communication module 311, a packet interpreter 312, a content execution controller 313, a content loader 315, a content execution unit 316, and virtual robots 3171 to 317n.

The communication module 311 is used for communication between connected robots and the computer content execution tool 320 or the content execution tool 330.

The packet interpreter 312 interprets a packet received from the communication module 311 or converts contents into a transmission packet and transfers the transmission packet to the robots and the computer execution tool 320.

The content execution controller 313 controls execution of contents such as start, pause, and resume execution.

The content loader 115 loads contents files 314 which are stored in various storage locations into a memory and transfers the loaded contents files 314 to the content execution controller 313.

The content execution unit 316 executes the contents files which are transferred from the content execution controller 313.

Each one of the virtual robots 3171 to 317n stores information on devices in the robots such as, sensors, microphones, actuators, and speakers, and a current status value which are generated for each connected robots.

The computer content execution tool 320 executes contents for computers which are transferred from the content execution engine 310.

The computer content execution tool 320 includes an image output module 321 which outputs a still image or moving picture content to a screen, an audio output unit 322 which outputs audio information such as voice or music to a speaker, and an hyper text mark-up language (HTML) output module 323 which outputs HTML to a screen.

In addition, an additional content type such as ActiveX and a module for outputting contents of the additional content type may be included as necessary.

The content execution control tool 330 checks what content the content execution engine 310 is currently executing and transfers a command for stop, pause, or resume execution of the contents which are currently being executed to the content execution engine 310 based on a user's request.

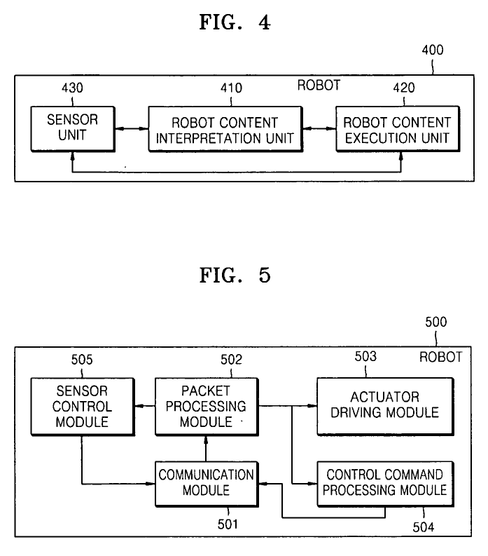

FIG. 4 is a block diagram of a robot according to an embodiment of the present invention. Referring to FIG. 4, the robot 400 includes a robot content interpretation unit 410, robot content execution unit 420, and a sensor unit 430.

The robot content interpretation unit 410 interprets a contents file which is acquired for executing contents included in a file transferred through a network and classifies the contents file according to an execution order.

The robot content execution unit 420 executes contents based on the execution order or executes the command including stop, pause, or resume execution of the contents which are transferred through the network.

The sensor unit 430 measures sensor information of the robot and transfers the sensor information to the user through a network.

FIG. 5 is a block diagram illustrating an internal software structure of a robot according to an embodiment of the present invention. Referring to FIG. 5, the robot 500 includes a communication module 501, a packet processing module 502, an actuator driving module 503, a control command processing module 504, and a sensor control module 505.

The communication module 501 is used for communication between the robot 500 and a robot control apparatus.

The packet processing module 502 interprets a packet which is transferred from the robot control apparatus. The packet processing module 502 transfers the packet to the actuator driving module 503 when the packet is an actuator driving packet and transfers the packet to the command processing module 504 for processing when the packet is a control packet.

The sensor control module 505 monitors sensor information inside the robot 500 and transfers the sensor information to the robot control apparatus through the communication module 501 when a change in the sensor information is detected.

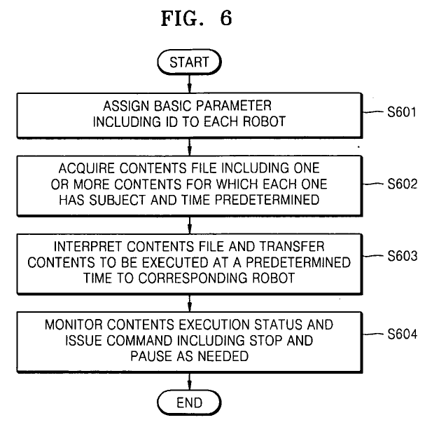

FIG. 6 is a flowchart of a method of controlling a robot according to an embodiment of the present invention. Referring to FIG. 6, in order to synchronously execute contents in two or more robots, a basic parameter including identification required for communication is assigned to each robot in preparation for communication, when the robot is connected (S601).

A contents file including one or more contents for which each one has an execution subject and an execution time predetermined is acquired (S602).

The contents file is interpreted, and contents that are to be executed at a predetermined time are transferred to a corresponding content subject (S603). When the execution subject of the content is the robot control apparatus, an image, audio, or the like to be executed in the apparatus plays.

An execution status of contents is monitored, and a command including stop, pause, or resume execution of the content is issued as necessary (S604).

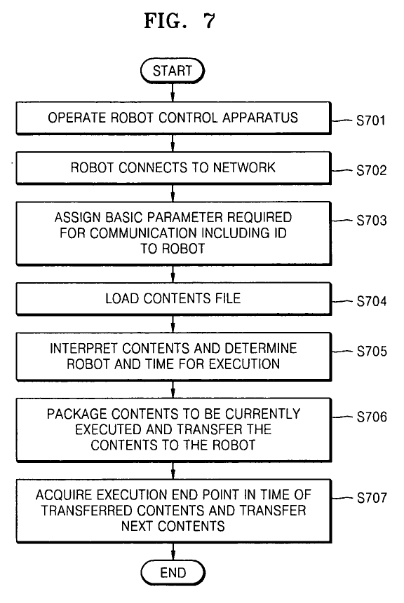

FIG. 7 is a flowchart of a method of controlling a robot according to another embodiment of the present invention. Referring to FIG. 7, a robot control apparatus is operated (Operation S701). A robot connects to the robot control apparatus through a network (Operation S702).

The robot control apparatus assigns an identification to each robot which is connected to the robot control apparatus and assigns a basic parameter including a window buffer size required to complete preparation of the communication (Operation S703).

The robot control apparatus loads a contents file which is in the robot control apparatus into a memory of the robot control apparatus (Operation S704).

The robot control apparatus interprets the loaded content and determines in which robot from among the connected robots the content will be executed or in which robot control apparatus the content will be executed (Operation S705).

The robot control apparatus checks contents that are to be executed at a present point in time. Contents are executed in the robot control apparatus when the content is determined to be executed inside the robot control apparatus. On the other hand, when the content is to be executed in the robot, the robot control apparatus packages the content and transfers the packaged content to the robot (Operation S706).

The robot interprets and executes the packet which is transferred from the robot control apparatus (Operation S707).

The robot control apparatus checks an end point in time of the contents which have been transferred to the robots and transfers a next content when the execution is completed (Operation S707).

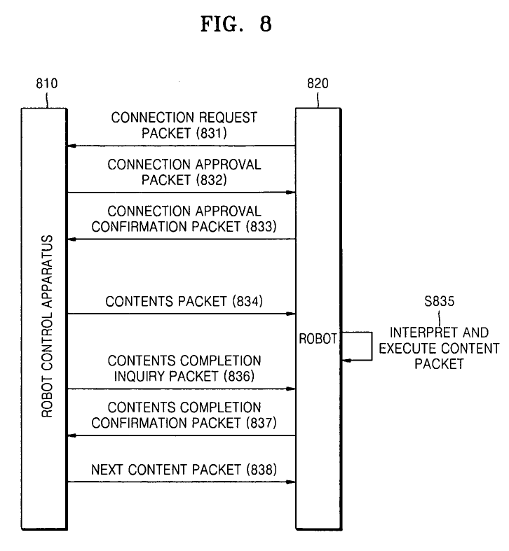

FIG. 8 is a flowchart of a method of controlling a robot according to another embodiment of the present invention. Referring to FIG. 8, the robot control apparatus 810 waits for packets at a predetermined private internet address, for example, 192.168.1.100, with a predetermined port number, for example, “2000”.

The robot 820 connects to the robot control apparatus 810 using the predetermined private internet address and the port number and sends a connection request packet together with the buffer size of the robot 820 to the robot control apparatus 810.

The robot control apparatus 810, which has received the connection request packet 831 from the robot 820, assigns an identification to the robot and sends a connection approval packet 832 together with the assigned identification to the robot 820.

The robot 820, which has received the connection approval packet 832, sends a connection approval confirmation packet 833 back to the robot control apparatus 810.

The robot control apparatus 810, which has received the connection approval confirmation packet 833 from the robot 820, generates a virtual robot object which is appropriate for the type of robot 820.

The robot control apparatus 810 loads and executes predetermined contents when all desired robots 820 are connected.

The robot control apparatus 810 determines contents to be executed at a predetermined point in time and transfers a corresponding content packet 834 to a computer content execution tool in the robot control apparatus 810 or the robot 820.

The computer content execution tool in the robot control apparatus 810 or the robot 820 which has received the content packet 834 interprets and executes the transferred content packet (Operation S835).

Some robots are required to execute the contents after execution of contents in other robots is completed.

As an example, when contents for performing English conversation between two different robots are executed, one robot should vocalize “Fine, and you?” after the other robot vocalizes “How are you?”.

The ordered or synchronized execution among robots is controlled by the robot control apparatus 810. The robot control apparatus 810 inquires whether execution of a content packet is completed after sending the content packet to the robot 820 by sending the robot 820 a content completion inquiry packet 836.

The robot, which has received the content completion inquiry packet 836, transfers a content completion confirmation packet 837 to the robot control apparatus 810 after executing the content packet which has been received before the content completion inquiry packet 834.

The robot control apparatus 810, which has received the content completion confirmation packet 837, is assured of the completion of the execution of the content packet 834 and then transfers a next content packet 838 which is to be executed next to the robot 820.

Various different methods other than the method using the content completion inquiry packet 836 and the content completion confirmation packet 837 may be used to confirm the completion of content execution.

In one of these methods, the robot 820 which has received the content packet 834 confirms the completion of the content execution to the content execution engine 11 after executing the content packet 834.

In another method, the robot 820 transfers the current number of content packets 834 which are not executed among contents packets 834 received from the robot control apparatus 810 to the robot control apparatus 810 at regular intervals, so that the robot control apparatus 810 can determine the completion of the execution of the content packet 834 using the transferred number.

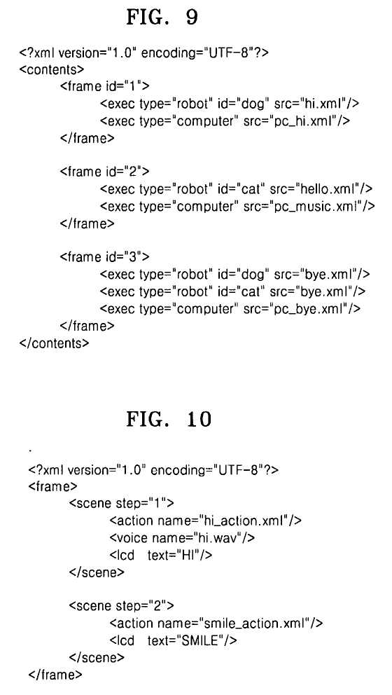

FIG. 9 is a contents file according to an embodiment of the present invention. Referring to FIG. 9, the contents file may be XML complex contents.

The contents, which are executed in the robot control apparatus, include complex contents including a combination of basic contents.

The basic contents include a voice file including wave and mpeg layer three (mp3) files, a still image which is played on a screen, a moving picture file, a text file, an XML file which describes a motion of a robot, and an HTML file. The complex contents include an XML file describing an operational flow on which basic contents are executed in each robot by combining the basic contents and a class library (hereinafter, referred to as class complex contents) which is written by a user in a programming language.

The XML of the XML complex contents are interpreted by the robot control apparatus and the XML complex contents are executed using a content execution unit. For the class complex contents, a content execution controller loads a corresponding class into a memory in order to generate an instant of the class, and an on Start( ) function is called to the class in order to execute the complex contents.

The class complex contents should implement on Start( ), on Stop( ), on Suspend( ), and on Resume( ) functions. The content execution controller calls on Start( ) and on Stop( ) functions when the contents start and ends, respectively. In addition, the content execution controller calls on Suspend( ) and OnResume( ) functions when the contents are paused and resumed, respectively.

The class complex contents continuously transfer contents that are to be executed at a predetermined point in time to the content execution controller. The content execution controller continuously executes the transferred contents.

The content execution file includes a plurality of frames which are described by multiple frame tags. The frame tag represents a bundle of contents that are to be executed simultaneously by the robots and the computer content execution tool.

An exec tag, which is located below the frame tag, includes a type tag which indicates whether the contents are to be executed in the robot or robot control apparatus, and identification of robots 20-1, 20-2 through to 20-n which are to execute the contents, and an src tag including a name of an XML file (hereinafter, referred to as a frame file) which describes basic contents that are to be executed.

As an example, for a frame having the identification of “1”, it is represented that the frame file “hi.xml” is executed by a robot which has the identification “dog”, and that the contents described in the frame file “pc_hi.xml” is executed in the computer. The content execution controller executes the frames sequentially one after another.

FIG. 10 is a frame file according to an embodiment of the present invention. Referring to FIG. 10, the frame file is executed in the robot.

A location of the basic contents file is described using a tag, which is in a scene tag of the frame file, such as an “action” representing an action of the robot, “voice”, “music”, “pic” representing a still image, and “mpic” representing a moving picture in a scene tag.

The content execution controller loads the basic contents using tag information and transfers the basic contents to the robot and the computer content execution tool in a predetermined order. The content execution controller sequentially executes scenes of the frame files that are to be transferred to each robot and the computer content execution tool in an ascending order of step numbers. When the step numbers of the scenes are the same, the scenes are simultaneously transferred to the robot and the computer content execution tool in order to be simultaneously executed, so that the execution of the contents are controlled and synchronized.

The contents execution controller executes a next scene after a previous scene ends completely. The method of controlling a robot illustrated in FIG. 8 is used for the contents execution controller to check whether the execution of a current scene is completed.

The frame information and scene information are transferred to the content execution controller for the class complex contents too. Procedures for executing the class complex contents thereafter are similar to the procedures for executing the content execution file described above.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, an apparatus and method of controlling a robot according to an embodiment of the present invention, comprises one or more robots, which are connected to a robot control apparatus through a network, which can synchronously execute the contents along with resources of the robot control apparatus such as a monitor and a speaker.

The present invention overcomes a disadvantage in a conventional robot control apparatus in that contents are executed only in one robot. In addition, most of the content processing is performed in the robot control apparatus to minimize processing performed in the connected robot.

In addition, the present invention can minimize the manufacturing costs of the robot. Furthermore, the contents can be downloaded through various mobile storage devices including a USB or the Internet so as to be directly executed in the robot control apparatus.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A robot control apparatus for synchronously executing contents in two or more robots, the robot control apparatus comprising:
an approval unit assigning a basic parameter required for communication including identification of each robot in order to prepare for communication when the robot is connected;
a contents file acquisition unit acquiring a contents file including one or more contents for which each one has an execution subject and an execution time predetermined; and
a contents file interpretation unit interpreting the contents file and transferring the contents that are to be executed at a predetermined time to the corresponding execution subject.

2. The robot control apparatus of claim 1, further comprising a content execution controller which monitors an execution status of the contents and issues a command including stop, pause, or resume execution of the contents as necessary.

3. The robot control apparatus of claim 1, wherein the execution subject of the contents is the robot or the robot control apparatus.

4. The robot control apparatus of any one of claims 1 to 3, further comprising a content execution unit comprising at least one of image and audio output parts for executing the contents when the subject of the contents is the robot control apparatus.

5. A robot executing contents included in a contents file transferred through a network, the robot comprising:
a robot content interpretation unit interpreting the acquired contents file and classifying the contents file according to an execution order; and
a robot content execution unit executing contents based on the execution order or executing the command including stop, pause, or resume execution of the contents which are transferred through the network.

6. The robot control apparatus of claim 5, further comprising a sensor unit measuring sensor information of the robot and transferring the sensor information to a user through the network.

7. A method of controlling two or more robots for synchronously executing contents, the method comprising:
(a) assigning a basic parameter required for communication including identification of each robot in order to prepare for communication when the robot is connected;
(b) acquiring a contents file including one or more contents for which each one has an execution subject and an execution time predetermined; and
(c) interpreting the contents file and transferring the contents that are to be executed at a predetermined time to the corresponding execution subject.

8. The method of claim 7, further comprising:
(d) monitoring an execution status of the contents and issuing a command including stop, pause, or resume execution of the contents as necessary.

9. The method of claim 7, wherein the execution subject of the contents is the robot or the robot control apparatus.

10. The method of any one of claims 7 to 9, further comprising executing the contents using at least one of image and audio output parts when the subject of the contents is the robot control apparatus.

11. A method of controlling a robot executing contents included in a contents file transferred through a network, the method comprising:
(a) interpreting the acquired contents file and classifying the contents file according to an execution order; and
(b) executing contents based on the execution order or executing the command including stop, pause, or resuming execution of the contents which are transferred through the network.

12. The method of claim 11, further comprising:
(c) measuring sensor information of the robot and transferring the sensor information to a user through the network.

13. A computer-readable medium having embodied thereon a computer program for executing the method of any one of claims 7 to 12.
